(19) United States
(12) Patent Application Publication
(10) Pub. No.: US 2009/0254428 A1
(43) Pub. Date: Oct. 8, 2009

(54) SYSTEMS AND METHODS FOR DELIVERING ADVERTISING CONTENT TO POINT OF SALE DEVICES

(75) Inventors: Jacob M. Sterling, St. Louis, MO (US); Andrew T. Hurt, Centennial, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/407,699

(22) Filed: Mar. 19, 2009

Related U.S. Application Data
(60) Provisional application No. 61/042,172, filed on Apr. 3, 2008.

(51) Int. Cl. G06Q 30/00; G06Q 20/00

(52) U.S. Cl. 705/14; 705/16; 705/17

(57) ABSTRACT

According to the invention, a system for delivering content to a user is disclosed. The system may include a point of sale device, a wide area network, and a payment processing system. The point of sale device may be configured to receive information regarding a transaction, and communicate content to the user. The wide area network may be in communication with the point of sale device. The payment processing system may be in communication with the wide area network, and may be configured to receive the information regarding the transaction, determine advertising content based at least in part on the information, and transmit the determined advertising content to the point of sale device.

### CROSS-REFERENCES TO RELATED APPLICATIONS

This application claims the benefit of U.S. Provisional Patent Application No. 61/042,172, filed Apr. 3, 2008, the complete disclosure of which is herein incorporated by reference.

### BACKGROUND OF THE INVENTION

This invention relates generally to content delivery to point of sale devices. More specifically the invention relates to advertising content deliver to point of sale devices across public networks based on transaction characteristics.

During transactions at service providers and merchants, consumers often interact with a point of sale device. This is especially true during transactions involving credit, debit, and/or Automated Teller Machine (“ATM”) cards. The point of sale device typically only informs the consumer of the cost of the transaction, and asks for approval and/or a signature.

The consumer usually pays close attention to this screen, as it will be the primary interaction during the actual moment of purchase where the precise amount of money exchanged with the service provider or merchant is verified and approved. Given the time and attention devoted by the consumer to the point of sale device during the transaction, an advantageous opportunity exists to provide the consumer with marketing materials, to the benefit of the consumer, service providers or merchants, producers of goods, and/or financial instrument issuers.

### BRIEF DESCRIPTION OF THE INVENTION

In one embodiment, a system for delivering content to a user is provided. The system may include a point of sale device, a wide area network, and a payment processing system. The point of sale device may be configured to receive information regarding a transaction, and communicate content to the user. The wide area network may be in communication with the point of sale device. The payment processing system may be in communication with the wide area network, and may be configured to receive the information regarding the transaction, determine advertising content based at least in part on the information, and transmit the determined advertising content to the point of sale device.

In another embodiment, a method for delivering content to a user is provided. The method may include receiving information at a point of sale device regarding a transaction. The method may also include communicating the information with a payment processing system via a wide area network. The method may further include determining advertising content based at in part on the information. The method may additionally include communicating the advertising content with the point of sale device via the wide area network. The method may moreover include communicating the advertising content to the user at the point of sale of device.

In another embodiment, a system delivering content to a user is provided. The system may include a first means, a second means, and a third means. The first means may be for receiving information regarding a transaction. The second means may be for determining advertising content based at least in part on the information. The third means may be for communicating the content to the user. The first means may include a point of sale device. The second means may include a payment processing system. The third means may also include a point of sale device, and in some embodiments may be the same point of sale device as the first means.

### BRIEF DESCRIPTION OF THE DRAWINGS

The present invention is described in conjunction with the appended figures:

FIG. 1 is a block diagram of a system embodiment of the invention for delivering content to a user of a point of sale device;

FIG. 2 is a block diagram of a method embodiment of the invention for delivering content to a user of a point of sale device; and

FIG. 3 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a system for delivering content to a user is provided. The system may include a point of sale device, a wide area network, and a payment processing system.

The point of sale device may be any device which interacts with a consumer at a point of sale. Merely by way of example, the point of sale device may be configured to accept credit cards, debit cards, ATM cards, stored value cards, coupons, gift cards, and/or etc. as payment for good and/or services at the location. Merely by way of example, the point of sale device may include a computer, a terminal, and/or a cash register. In different embodiments, the configuration of the point of sale devices may vary. Merely by way of example, in some embodiments, a terminal alone may be used to process the financial portion of the transaction. In other embodiments, a computer running point of sale software, for example, either locally or via the Internet (possibly via a service such as Linkpoint®) may be the point of sale device.

The different point of sale devices may have different capabilities. Merely by way of example, the display and input capabilities could vary. In some embodiments, the point of sale device could have a two-tone display screen, while in other embodiments, full range color display screens may be provided. Audio capabilities may also be present in some point of sale devices. These or other point of sale devices may also have printing capabilities. Input capabilities on various point of sale devices of the invention may include, merely by way of example, touch screens, stylus input screens, buttons, etc.

The point of sale devices may be configured to receive information regarding a transaction, and communicate content to the user. The information received by the point of sale device, including any portion thereof, may include information about the transaction including the details about the goods and/or services purchased such as the identifiers of such goods and/or services and prices thereof. Other information received by the point of sale device may include, merely by way of example, identifying information regarding the payment method (cash, checks, credit cards, debit cards, ATM cards, stored value cards, coupons, gift cards, and/or etc.). The identifying information regarding the payment method may include information which identifies the financial institution issuer of the check, credit card, debit card, ATM card, stored value card, coupon, and/or gift card used in the transaction by the user.

In some embodiments, any of the information received by the point of sale device may be transmitted to a wide area network (possibly the Internet) that may be in communication with the point of sale device. The payment processing system may be in communication with the wide area network, and may be configured to receive any of the information regarding the transaction.

The payment processing system may be configured to determine advertising content based at least in part on the information received. Merely by way of example, the advertising content may include an advertisement, and/or a coupon. The advertisements may be passive and may include, merely by way of example, promotional messages informing a user of products or services, characteristics of products or services, prices of products or services, terms of sale of products or services, etc. In some embodiments, the advertisements may be active and may include coupons. Coupons may include, merely by way of example, partial and/or total discounts on goods and/or services.

The type of advertising content selected may depend on the information received by the payment processing system. Merely by way of example, if the information received by the payment processing system is information about a sale of a specific good or goods, then the advertising, passive or coupon, may be related to the specific good or goods, related goods, related services, and/or competing goods and services.

Related goods may be goods which are associated with specific good or goods involved in the transaction. Merely by way of example, if the specific goods in a transaction include a vacuum cleaner, then related goods might include replacement brushes and/or replacement vacuum bags for the vacuum cleaner involved in the transaction. In such an example, related services might be repair services for the specific vacuum cleaner, and competing goods might be vacuum cleaners of another brand, with competing services including maid services. In other embodiments, related goods and/or services to the specific goods and services involved in the transaction may merely include unrelated goods and/or services offered by the same merchant and/or service provider involved in the transaction.

In some embodiments, the information received by the payment processing system may include information about cash, checks, credit cards, debit cards, ATM cards, stored value cards, coupons, gift cards, and/or etc. used in the transaction by the user. In some embodiments, the payment processing system may select advertising content based at least partially on this information. Merely by way of example, advertising, both passive and coupon type, may be related to goods and/or services provided by the financial institution associated with the payment method used by the user in the transaction. This may assist in increasing business for the financial institution by actively encouraging the user in the transaction to seek services, or merely by increasing name recognition of the financial institution.

In some embodiments, the payment processing system may also receive information regarding the capabilities of the point of sale device used in the transaction. As described above, the point of sale device of the invention may have varying capabilities. The payment processing system may in turn use the information regarding the capabilities of the point of sale device to select an appropriate advertising content. Merely by way of example, the advertising content may be selected based on the display capabilities of the point of sale device (i.e. color advertising content for color display point of sale devices, two-tone advertising content for two-tone display point of sale devices).

Interactive advertising content, such as certain coupons may also depend on there being certain interactive input capabilities available in or at the point of sale device merely by way of example, if a coupon advertising content requires acceptance by the user in the transaction, therefor possibly necessitating input capabilities for the point of sale device. In some embodiments then, the payment processing system may determine the capabilities of the point of sale device from which the information was received and determine advertising content based at least in part on what capabilities are available.

The payment processing system may further be configured to transmit the advertising content to the point of sale device, possibly via the wide area network. The advertising content may then be delivered by the point of sale device to the user (for example, visually or audibly).

When interactive advertising content is delivered to the user, the user may provide inputs to the point of sale device. For example, the user may accept an offered coupon. This input may be transmitted to the payment processing system and stored there for immediate and/or future reference. Merely by way of example, the input may affect the immediate transaction, possibly by changing the cost to the user. The input may also be stored if it is designed to affect a future transaction, for example, if a coupon has been accepted that is good towards a future transaction. At the future time when the transaction specified by the coupon occurs involving the same user (or another user specified in the arrangement), reference may be made to the stored input and the terms of the coupon applied to a then-occurring transaction.

In another embodiment of the invention, a method for delivering content to a user is provided. The method may include receiving information at a point of sale device regarding a transaction. The method may also include communicating the information with a payment processing system via a wide area network. The method may further include determining advertising content based at in part on the information. The method may additionally include communicating the advertising content with the point of sale device via the wide area network. The method may moreover include communicating the advertising content to the user at the point of sale of device.

In some embodiments the method may also include selectable advertising content being transmitted or otherwise provided by goods providers, service providers, and/or financial instrument issuers to the payment processing system or a system associated therewith. In some embodiments, there may be a direct or indirect communication between the parties to facilitate original transmittal and/or updating of selectable advertising content.

In addition to the selectable advertising content, the goods providers, service providers, and/or financial instrument issuers may also transmit or otherwise provide selection criteria for each piece of selectable advertising content. The selection criteria may define parameters for the payment processing system to examine when determining which advertising content to provide for a given transaction. As discussed above, different goods or services purchased in a transaction may trigger delivery of different advertising content, just as different financial instrument usage may also trigger different advertising content.

In another embodiment of the invention, a system delivering content to a user is provided. The system may include a first means, a second means, and a third means.

The first means may be for receiving information regarding a transaction. The first means may, merely by way of example, include a point of sale device or any other component discussed herein or otherwise now or in the future known in the art for such purposes.

The second means may be for determining advertising content based at least in part on the information. The second means may, merely by way of example, include a payment processing system or any other component discussed herein or otherwise now or in the future known in the art for such purposes.

The third means may be for communicating the content to the user. The third means may, merely by way of example, include a point of sale device or any other component discussed herein or otherwise now or in the future known in the art for such purposes. In some embodiments, the first means and the third means may be integrated and/or the same component.

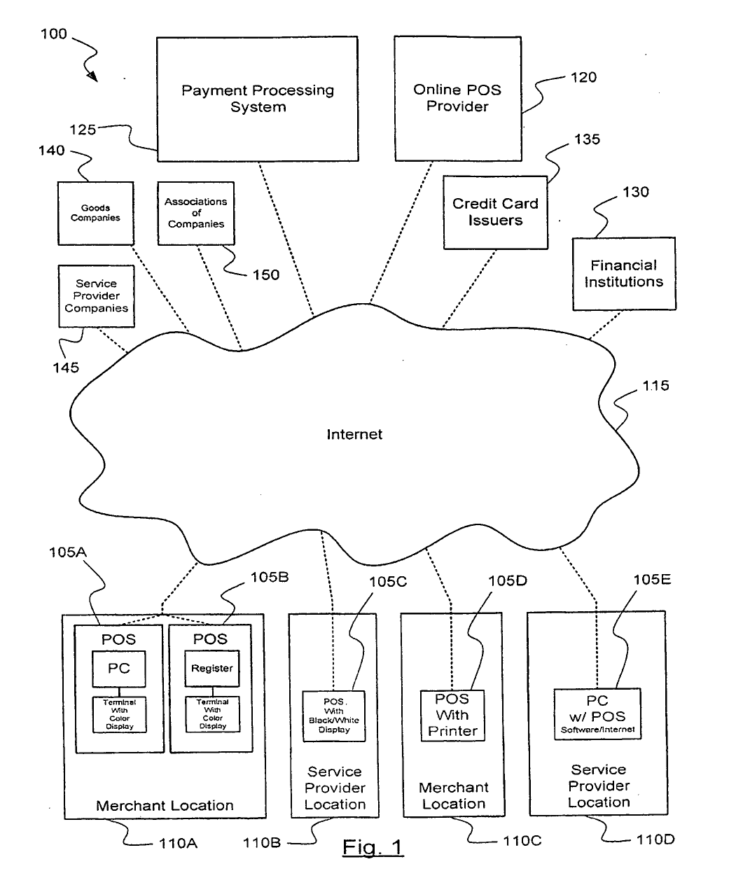

Turning now to FIG. 1, a block diagram example of a system 100 of the invention for delivering content to users of point of sale devices 105 is shown. System 100 shown in FIG. 1 is just one example of how one embodiment of the invention may function during application to financial transactions in a variety of circumstances.

Point of sale devices 105 may each be located at different locations. In the example shown, point of sale device 105A and point of sale device 105B are located at a first merchant location 110A (solely for the purposes of this example, first merchant location 110A may be a consumer electronics store). Point of sale device 105A may include a personal computer and a terminal with color display. Point of sale device 105B may include a cash register and a terminal with color display. Other point of sale devices 105 may also exist at first merchant location 110A, but are not shown in this figure.

Point of sale device 105C may be located at a first service provider location 110B (solely for the purposes of this example, first service provider location 110B may be a barber shop). Point of sale device 105C may include a terminal with black and white display. Other point of sale devices 105 may also exist at first service provider location 110B, but are not shown in this figure.

Point of sale device 105D may be located at a second merchant location 110C (solely for the purposes of this example, second merchant location 110B may be a grocery store). Point of sale device 105D may include a terminal with a printer. Other point of sale devices 105 may also exist at second merchant location 110C, but are not shown in this figure.

Point of sale device 105E may be located at a second service provider location 110D (solely for the purposes of this example, second service provider location 110D may be a car wash). Point of sale device 105E may include a personal computer running point of sale software, either locally, or via a wide area network 115 (shown here as the Internet) using an online point of sale software service provider 120 (for example, Linkpoint®). Other point of sale devices 105 may also exist at second service provider location 110D, but are not shown in this figure.

Point of sale devices 105 may be in communication with a payment processing system 125 over wide area network 115, and possibly via a communication network (for example Datawire®) utilizing wide area network 115 as a transport medium. Payment processing system 125 may process transactions which occur at the point of sale devices 105, and interact as necessary with the financial institutions 130 associated with the merchants 110 and service providers 110, as well as the financial institutions 130 or credit card issuers 135 which are associated with, or issue the financial instruments used by, the consumers at the point of sale devices 105 (which is not necessarily the same financial institution as that of the merchant/service provider). The payment processing system may be in communication with financial institutions via the wide are network 115, and/or another distinct financial transaction network (not shown in FIG. 1).

Meanwhile, goods companies 140, service provider companies 145, and/or other associations of companies 150 may be in communication with the payment processing system 125, possible via wide area network 115. Through this communication, the goods companies 140, service provider companies 145, and/or other associations of companies 150 may provide selectable advertising content to the payment processing system 125, possibly along with selection criteria for each piece of selectable advertising content. In some embodiments, groups of goods companies and/or service providers 150 may make agreements amongst themselves to provide certain libraries of selectable advertisement content.

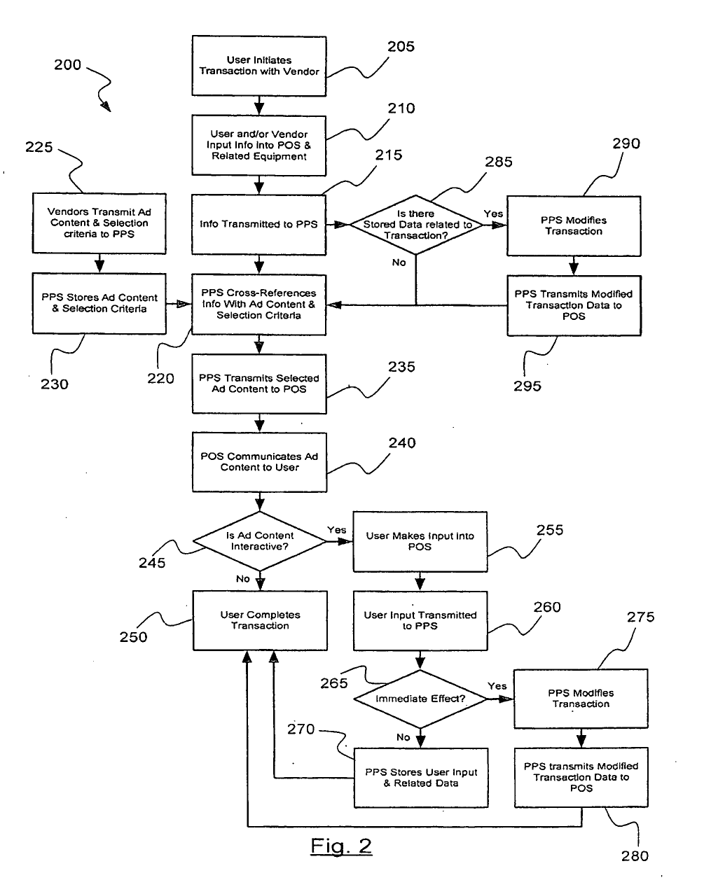

With reference also to FIG. 2, a block diagram of a method 200 of the invention for delivering content to a user of a point of sale 105 device possibly via system 100 is shown.

At block 205, a user initiates a transaction with a vendor at a vender location 110. At block 210, information related to the transaction (for example, type and quantity of goods and/or services to be purchased, cost thereof, and payment method information) is input into point of sale device 105 and related equipment.

At block 215, the above information, possibly along with information regarding the capabilities of point of sale device 105 and related equipment is transmitted to payment processing system 125. At block 220, payment processing system 125 cross references the received information with stored advertising content and selection criteria which was previously transmitted by vendors and possibly other parties at block 225, and stored by payment processing system 125 at block 230.

By cross referencing the received information with the stored advertising content and selection criteria, the proper advertising content is selected. At block 235, payment processing system 125 transmits the selected advertising content to point of sale device 105. At block 240, point of sale device 105 communicates the advertising content to the user.

As discussed above, the advertising content may be communicated via audio and/or video means, as well as by printed means in some embodiments. In the example shown in FIG. 1, advertising content may be delivered via color visual displays at point of sale devices 105A, 105B; via black and white visual displays at point of sale device 105C; via printed material at point of sale device 105D; and via any of these or other means, as available, at point of sale device 105E. Payment processing system may take such available functionality into account when selecting advertising content for respective point of sale devices 105. Consequently, providers of advertising content may provide different advertising content to payment processing system 125 for the various types of point of sale devices 105.

At block 245, method 200 determines if the advertising content is interactive. If not, the transaction is completed in default fashion at block 250. If the advertising content is interactive, then at block 255 the user may make an input into point of sale device 105. The input may for example be acceptance of a coupon or discount offer, effective either for the current transaction or a future transaction. At block 260, this input may be transmitted to payment processing system 125.

At block 265, method 200 determines if the user's input and/or the advertising content necessitates an immediate effect on the current transaction. If not, the user's input, for example, the acceptance of a coupon or discount offer for future usage at the same or other business, is stored for future reference at block 270. The transaction is then completed at block 250.

If method 200 determines that the user's input and/or the advertising content necessitates an immediate effect on the current transaction, then at block 275, payment processing system 125 may modify the terms of the transaction. At block 280, the modified terms of the transaction are transmitted to point of sale device 105, and the transaction is completed with the modified terms at block 250. In other embodiments, any modification of the transaction in the method may occur solely at point of sale device 105, with only instructions to do so coming from payment processing system 125, either at the original transmittal of the advertising content, or at any point later in the method.

When advertising and corresponding user inputs are stored for later reference at block 270, they may affect future transactions by the user. At block 285, method 200 may determine whether stored data (possibly a previously user accepted coupon or discount offer) applies to the instant transaction. This data may be stored at payment processing system 125 in some embodiments. If no stored data applied to the instant transaction, method 200 continues normally at block 220. If stored data does apply to the instant transaction, then at block 290, payment processing system 125 modifies the terms of the transaction, and transmits the modified terms to point of sale device 105 at block 295. As above, modification of the terms of the instant transaction may also occur at point of sale device 105. Even when the terms of the instant transaction are modified by stored data, new advertising content may still be determined for the instant transaction and method 200 may proceed normally after such a process.

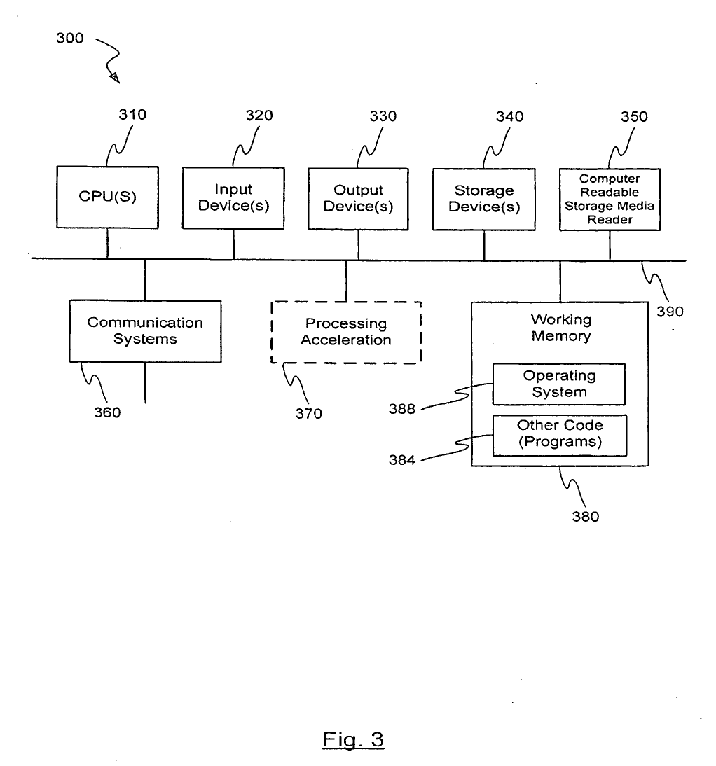

FIG. 3 is a block diagram illustrating an exemplary computer system 300 in which embodiments of the present invention may be implemented. This example illustrates a computer system 300 such as may be used, in whole, in part, or with various modifications, to provide the functions of the point of sale device, the payment processing system, and/or other components of the invention such as those discussed above. For example, various functions of the payment processing system may be controlled by the computer system 300, including, merely by way of example, receiving information from the point of sale device, storing advertising content, selecting advertising content, storing coupons accepted by users, processing transactions, and/or etc.

The computer system 300 is shown comprising hardware elements that may be electrically coupled via a bus 390. The hardware elements may include one or more central processing units 310, one or more input devices 320 (e.g., a mouse, a keyboard, etc.), and one or more output devices 330 (e.g., a display device, a printer, etc.). The computer system 300 may also include one or more storage device 340. By way of example, storage device(s) 340 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 350, a communications system 360 (e.g., a modem, a network card (wireless or wired), an infra-red communication device, Bluetooth™ device, cellular communication device, etc.), and working memory 380, which may include RAM and ROM devices as described above. In some embodiments, the computer system 300 may also include a processing acceleration unit 370, which can include a digital signal processor, a special-purpose processor and/or the like.

The computer-readable storage media reader 350 can further be connected to a computer-readable storage medium, together (and, optionally, in combination with storage device(s) 340) comprehensively representing remote, local, fixed, and/or removable storage devices plus storage media for temporarily and/or more permanently containing computer-readable information. The communications system 360 may permit data to be exchanged with a network, system, computer and/or other component described above.

The computer system 300 may also comprise software elements, shown as being currently located within a working memory 380, including an operating system 384 and/or other code 388. It should be appreciated that alternate embodiments of a computer system 300 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 300 may include code 388 for implementing any or all of the function of the various elements of the architecture as described herein. For example, software, stored on and/or executed by a computer system such as system 300, can provide the functions of the point of sale device, the payment processing system, and/or other components of the invention such as those discussed above. Methods implementable by software on some of these components have been discussed above in more detail.

A number of variations and modifications of the invention can also be used within the scope of the invention. For example, the advertising content may include surveys which may be completed by the user and transmitted back to the payment processing system for compilation and analysis by merchants, service providers, and financial instrument issuers. In other embodiments, news, weather, and sports information such as scores and game times may be presented by the point of sale device at the direction of the payment processing system. In some of thee or other embodiments, point of sale terminals may also be located at financial institutions, and perform similar advertising content delivery functions.

The invention has now been described in detail for the purposes of clarity and understanding. However, it will be appreciated that certain changes and modifications may be practiced within the scope of the appended claims.

What is claimed is:

1. A system for delivering content to a user, wherein the system comprises:
a point of sale device, wherein the point of sale device is configured to:
receive information regarding a transaction; and
communicate content to the user;
a wide area network in communication with the point of sale device; and
a payment processing system, wherein the payment processing system is in communication with the wide area network, and wherein the payment processing system is configured to:
receive the information regarding the transaction;
determine advertising content based at least in part on the information; and
transmit the determined advertising content to the point of sale device.

2. The system for delivering content to a user of claim 1, wherein:
the information regarding the transaction comprises information regarding goods or services involved in the transaction; and
determining advertising content based at least in part on the information comprises determining advertising content based at least in part on the goods or services involved in the transaction.

3. The system for delivering content to a user of claim 2, wherein the advertising content comprises a coupon for goods or services related to the goods or services involved in the transaction.

4. The system for delivering content to a user of claim 1, wherein:
the information regarding the transaction comprises information regarding a payment method involved in the transaction; and
determining advertising content based at least in part on the information comprises determining advertising content based at least in part on the payment method involved in the transaction.

5. The system for delivering content to a user of claim 4, wherein the payment method involved in the transaction comprises a financial instrument and the advertising content comprises a coupon for goods or services purchased with the financial instrument.

6. The system for delivering content to a user of claim 1, wherein:
the point of sale device is further configured to receive an input from the user accepting a coupon included in the advertising content.

7. The system for delivering content to a user of claim 6, wherein the payment processing system is further configured to:
store information based on the input from the user; and
modify the transaction based at least in part on the stored information.

8. The system for delivering content to a user of claim 1, wherein the payment processing system is further configured to:
determine at least one capability of the point of sale device; and
determine advertising content further based at least in part on the capability of the point of sale device.

9. The system for delivering content to a user of claim 1, wherein the wide area network comprises the Internet.

10. A method for delivering content to a user, wherein the method comprises:
receiving information at a point of sale device regarding a transaction;
communicating the information with a payment processing system via a wide area network;
determining advertising content based at in part on the information;
communicating the advertising content with the point of sale device via the wide area network; and
communicating the advertising content to the user at the point of sale of device.

11. The method for delivering content to a user of claim 10, wherein the method further comprises receiving selectable advertising content from a selection from a group consisting of:
a goods provider;
a service provider; and
a financial instrument issuer.

12. The method for delivering content to a user of claim 10, wherein the method further comprises:
receiving, by an operator of the payment processing system, selectable advertising content from a financial instrument issuer; and
receiving, by the operator of the payment processing system, a payment from the financial instrument issuer.

13. The method for delivering content to a user of claim 12, wherein the method further comprises receiving, by a merchant associated with the point of sale device, a payment from the operator of the payment processing system.

14. The method for delivering content to a user of claim 10, wherein the advertising content comprises a coupon for goods or services:
(i) not purchased in the transaction; and
(ii) related to a good or a service purchased in the transaction.

15. The method for delivering content to a user of claim 10, wherein the advertising content comprises a coupon and an advertising message from a financial instrument issuer associated with the transaction.

16. A system delivering content to a user, wherein the system comprises:
a first means for receiving information regarding a transaction;
a second means for determining advertising content based at least in part on the information; and
a third means for communicating the content to the user.

17. The system delivering content to a user of claim 16, wherein the first means comprises a point of sale device.

18. The system delivering content to a user of claim 16, wherein the second means comprises a payment processing system.

19. The system delivering content to a user of claim 16, wherein the third means comprises a point of sale device.

20. The system delivering content to a user of claim 16, wherein the first means is integrated with the third means.
